(19) United States
(12) Patent Application Publication
(10) Pub. No.: US 2013/0139391 A1
(43) Pub. Date: Jun. 6, 2013

(54) POLE PRUNER

(71) Applicant: William J. Nelson, II, Solon, OH (US)

(72) Inventor: William J. Nelson, II, Solon, OH (US)

(73) Assignee: CI, LLC, Solon, OH (US)

(21) Appl. No.: 13/683,558

(22) Filed: Nov. 21, 2012

Related U.S. Application Data
(60) Provisional application No. 61/563,060, filed on Nov. 23, 2011.

(51) Int. Cl. A01G 3/08

(52) U.S. Cl. CPC A01G 3/085
USPC 30/276; 30/329

(57) ABSTRACT

A cutting tool for cutting vegetation including a rotary cutting bit adapted to be advanced through the vegetation in a direction perpendicular to a rotational axis of the bit. The rotary cutting bit can be supported by two bit supports spaced apart axially. The tool can include an extension pole which allows the rotary tool to be mounted adjacent a distal end of the pole. In this way high branches and the like can be cut.

### BACKGROUND

The present exemplary embodiment relates to a pruning device for pruning vegetation. It finds particular application in conjunction with a device for trimming limbs of a tree, and will be described with particular reference thereto. However, it is to be appreciated that the present exemplary embodiment is also amenable to other like applications.

Pruning devices are generally used to cut branches and limbs of trees and bushes. Basic pruning devices generally include a saw or shears for such cutting. Some pruning devices are adapted for remote operation and may include a saw blade or shears mounted on a pole. In the case of a saw, a user engages the saw blade with a branch to be cut, and then saws through the branch using a reciprocating motion. In the case of shears, the user aligns the jaws of the shear with a branch to be cut, and then snips the branch by manipulating a rope or other mechanism designed to remotely operate the shears. Such pruners are generally difficult to operate, particularly for those with limited upper body strength, and can result in imprecise cuts and scarring or damage to the tree.

Other pruning devices are known including U.S. Pat. No. 5,787,536, which discloses a chain saw cutting device designed to be suspended by a hook from a branch of a tree above the branch to be cut, and U.S. Pat. No. 5,411,238 which discloses an elongated shaft attached to a hedge trimmer handle.

Another remote pruning device is disclosed in U.S. Pat. No. 6,901,695, wherein an electric router is mounted to an elongated rod. The electric router includes a fluted cutting bit installed in a chuck of the router and adapted to laterally cut through a small diameter limb or branch of vegetation such as a tree. As noted in the specification, this device can be difficult to operate. For example, when beginning a cut, it can be difficult to maintain a constant pressure on the cutting bit. To overcome this challenge, a spring-tensioned hook device is disclosed that allows the tool to be hooked over a branch at the cutting point. The router can then be rotated to advance the cutting bit through the branch to effect the cut. Although the hook device may make using this device easier, it adds weight, size and complexity to the assembly.

The prior art pruning devices have been found to be difficult to operate due to weight and/or size, produce imprecise cuts, and/or require two hands to operate effectively which can make pruning dangerous.

### BRIEF DESCRIPTION

In accordance with one aspect of the present disclosure, a cutting tool for cutting vegetation comprises an elongate pole member having a first end for supporting an associated rotary cutting bit and a second end opposite the first end for grasping by an operator during use, and a rotary cutting device supported at the first end of the elongate member, the rotary cutting device including a rotational drive member for spinning the associated rotary cutting bit, and first and second spaced apart bit supports for supporting the associated rotary cutting bit for rotation at spaced apart locations along its longitudinal axis. The cutting tool is configured for cutting vegetation with the associated rotary cutting bit between the first and second spaced apart bit supports while being manipulated by an operator grasping the elongate pole member.

The rotary cutting device can include a motor for driving the associated rotary bit, and at least one of the first and second spaced apart bit supports is supported on an output shaft of the motor. The rotary cutting device can further include a housing in which at least a portion of the motor is contained, and a support arm extending from the housing supporting at least one of the bit supports. The support arm can be removably attached to the housing. The support arm can be adjustable to vary a longitudinal spacing between the first and second bit supports for accommodating bits of various axial lengths. The housing can include one or more bit retainers for holding one or more rotary cutting bits. The motor can be at least one of an electric motor, a pneumatic motor, or a hydraulic motor. At least one of the first and second bit supports can include a collet for engaging a shank of the associated rotary cutting bit.

The elongate pole member can include a telescoping portion for adjusting a length of the pole member. The elongate pole member can include a control mechanism located closer to the second end thereof for enabling a user to remotely activate the rotary cutting device. The control mechanism can include a switch that is coupled to the rotary cutting device by a cord having a coupling member for coupling the switch to the rotary cutting device. The rotary cutting device is detachable from the elongate pole member and further includes a trigger switch for handheld operation of the cutting tool when it is detached from the elongate pole member.

In accordance with another aspect of the present disclosure, a cutting attachment for use with an associated rotary tool comprises a rotary cutting bit support member attachable to a housing of the associated rotary tool, the rotary cutting bit support member including at least one bit support for supporting an associated rotary cutting bit for rotation at a spaced apart location from the housing of the associated rotary cutting tool, whereby an associated rotary cutting bit can be supported at a first end by the associated rotary cutting tool and at a second end by the at least one bit support.

The rotary cutting bit support member can include first and second arm members, the first, arm member can be securable to the associated rotary tool, and the second arm member can be adjustably securable to the first arm member to vary a longitudinal spacing between the housing of the associated rotary tool and the second member. The attachment can further include an adjustment lock mechanism for selectively locking the first and second arm members together in a plurality of positions. The rotary cutting bit support can further include a pole extension receiver removably attachable to the rotary cutting bit support. The pole extension receiver can be adapted to receive a pole member. The at least one bit support can include a bearing. The bearing can be removable from the rotary cutting bit support member.

### BRIEF DESCRIPTION OF THE DRAWINGS

FIG. 1 is a perspective view of an exemplary cutting tool in accordance with a first embodiment of the present disclosure;

FIG. 1B is a side elevational view of the upper portion of the cutting tool of FIG. 1A;

FIG. 2 is a plan view of the exemplary cutting tool;

FIG. 3 is a perspective view of the exemplary cutting tool without the pole attached;

FIG. 4 is a perspective view of the exemplary cutting tool with the pole attached;

FIG. 5 illustrates the exemplary cutting tool in operation;

FIG. 6 is a perspective view of the exemplary cutting tool in accordance with a second embodiment of the present disclosure;

FIG. 7 is another perspective view of the cutting tool of FIG. 6;

FIG. 8 is an exploded view of another exemplary cutting tool in accordance with the present disclosure;

FIG. 9 is a perspective view of the cutting tool of FIG. 8 in an assembled state;

FIG. 10 is an exploded perspective view of a pole and bracket, according to a further embodiment of the present disclosure, for supporting a cutting tool;

FIG. 11 is a side elevational view of another embodiment of a cutting tool according to the present disclosure.

### DETAILED DESCRIPTION

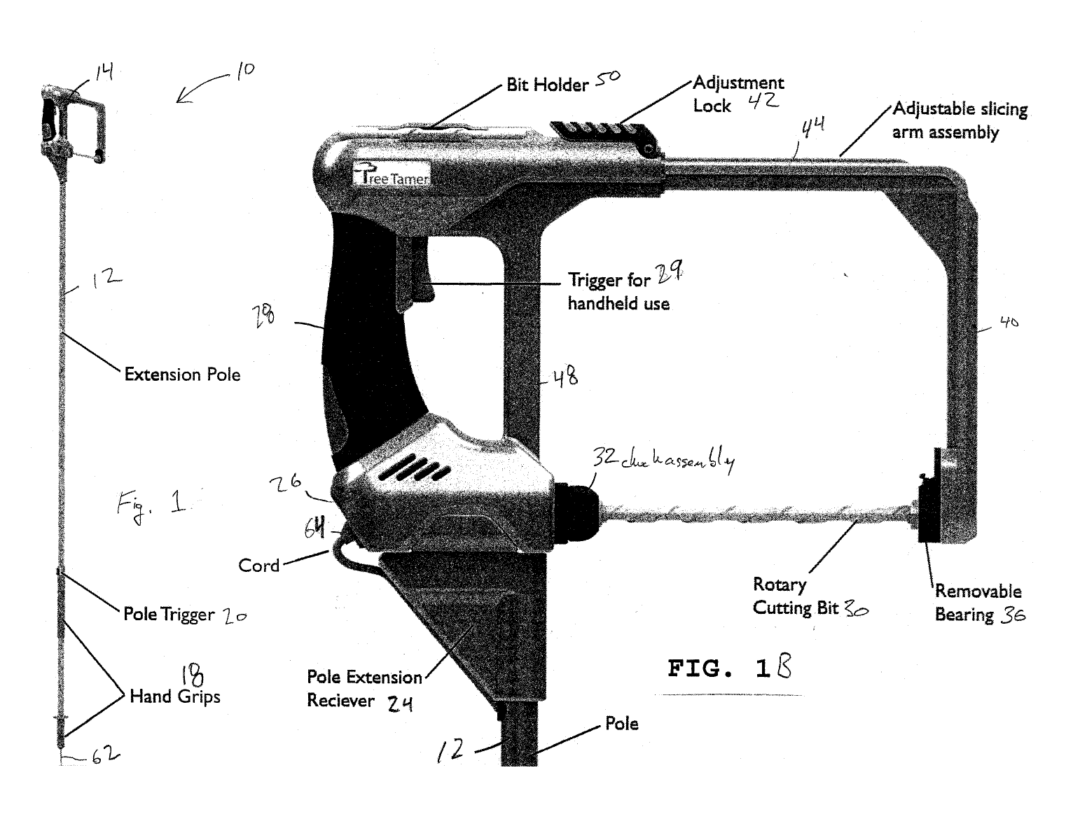

With reference to FIG. 1, a first exemplary cutting tool for cutting vegetation in accordance with the disclosure is illustrated and identified generally by reference numeral 10. The cutting tool 10 includes a pole member 12 and a rotary cutting device 14 supported at an upper end of the pole member 12. At the opposite end of the pole member 12, a pair of spaced apart handgrips 18 are provided along with a control mechanism in the form of pole trigger 20 that is designed to remotely activate the rotary cutting device 14. The pole member 12 can be a telescoping pole and/or can be composed of a plurality of pole segments whereby the overall length of the pole member 12 can be adjusted.

With further reference to FIGS. 1B, 2 and 3, the details of the rotary cutting device 14 will be described. As noted, the rotary cutting device 14 is supported on the pole member 12. To this end, a pole extension receiver 24 engages the upper end of the pole member 12 and is secured to a housing 26 of the rotary cutting device 14. The pole member 12 can be connected to the rotary cutting device 14 in a variety of different manners known in the art, such as, for example, by threads on the terminal end of the pole member 12 that engage mating threads provided in the pole extension receiver 24. The pole extension receiver 24 can be configured to interlock with the housing 26 of the rotary cutting device 14 thereby securing the pole member 12 to the rotary cutting device 14. Various known quick-connect coupling mechanisms can be employed to allow quick connect/disconnect of pole extension receiver 24 from housing 26.

The housing 26 of the rotary cutting device 14 includes a pistol grip portion 28 designed to be grasped in a user's hand when the rotary cutting device 14 is used without the pole member 12 such as in a manner described herein. A trigger switch 29 is provided for activating the rotary cutting device 14. Supported within the housing 26 is a motor (not shown), such as an electric motor, for rotating a rotary cutting bit 30 that is operatively connected to an output shaft of the motor. In the illustrated embodiment, the rotary cutting bit 30 is fixed for rotation with the output shaft of the motor by a chuck assembly 32 that is designed to compressively engage a shank portion of the rotary cutting bit 30. The end of the rotary cutting bit 30 opposite that which is received in the chuck assembly 32, is supported by a bearing 36 that is configured to support the rotary cutting bit for rotation. Bearing 36, which may be a removable bearing, is supported on a support arm 40 that extends from the housing 26 of the rotary cutting device 14.

Support arm 40 is adjustably secured to the housing 26 by an adjustment lock member 42. Support arm 40 is slidably received within the housing 26 such that a spacing between the removable bearing 36 and the chuck assembly 32 can be varied to accommodate rotary cutting bits of various lengths. Support arm 40 includes a rail 44 that is received in a corresponding groove provided on the interior of the housing 26 such that the support arm 40 is guided in linear fashion between a fully extended position and a fully retracted position. Adjustment lock member 42 is provided for locking the support arm 40 to the housing 28 to restrict movement of the support arm 40. Adjustment lock member 42 may be a cam lock or other suitable locking device.

The housing 26 of the rotary cutting device 14 also includes a hand guard/support member 48 extending between a lower portion of the housing 26 including the electric motor and an upper portion adapted to receive the support arm 40. The hand guard/support member 48 restricts or prevents contact between a user's hand and vegetation during cutting. The hand grip/support member 48 also increases the structural rigidity of the rotary cutting device 14. The housing 26 further includes a pair of rotary cutting bit holders 50 that are adapted to retain spare rotary cutting bits. The lower portion of the housing 26, as noted, can include an interlock feature 52 that is configured to cooperate with the pole extension receiver 24 when the rotary cutting device 14 is used in connection with a pole member 12.

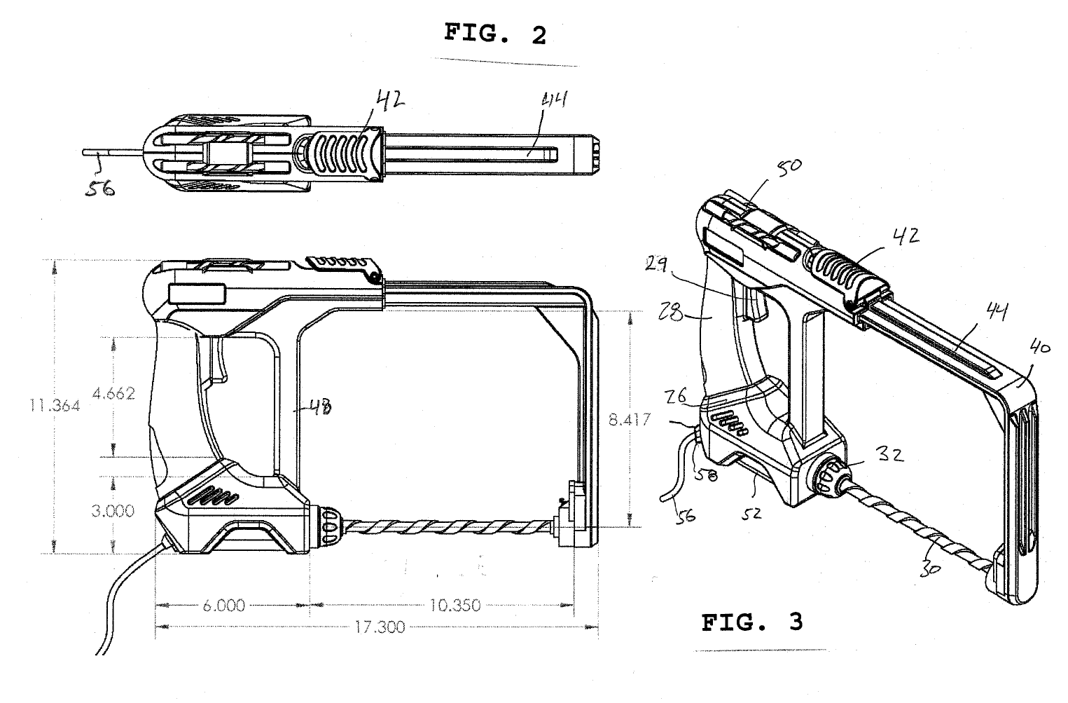

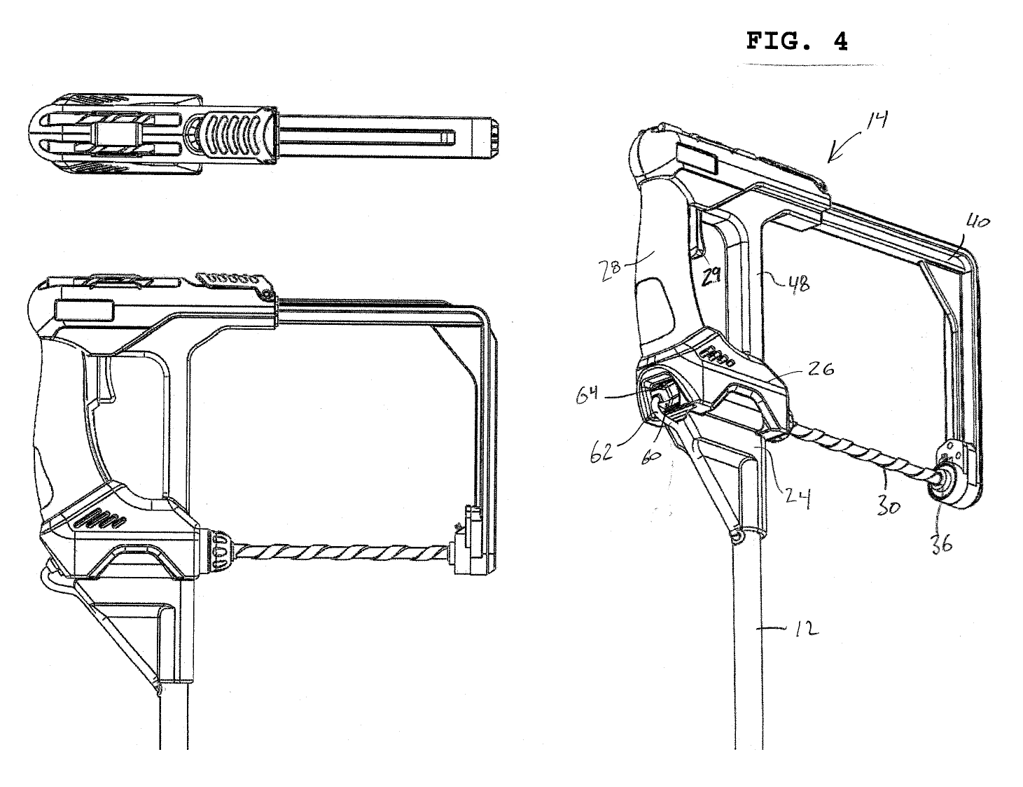

In FIGS. 2 and 3, power is supplied to the electric motor of the rotary cutting device 14 by a cord 56. Cord 56 includes a plug 58 that is received in a socket 60 (see FIG. 4) formed in the housing 26. In this configuration, the rotary cutting device 14 is not used in conjunction with the pole member 12, and the cord 56 is configured to be plugged into a wall outlet or other source of electric power. The rotary cutting device 14 can then be used by grasping the pistol grip 28 and activating the electric motor by using trigger switch 64.

When the rotary cutting device 14 is used in conjunction with pole member 12, such as shown in FIGS. 1B and 4, a separate cord and plug is provided for powering the rotary cutting device 14. As shown in FIG. 4, a cord 62 and plug 64 extends from pole extension receiver 24 for connection to socket 60. Cord 62 is routed through pole member 12 and extends along the length of the interior of pole member 12 and out the lower end of the pole member 12 (as seen in FIG. 1A). Cord 62 is also configured to be plugged into a wall outlet or other source of electrical power. As will be appreciated, routing the cord 62 on the inside of pole member 12 is convenient for preventing the cord 62 from tangling with vegetation during a cutting operation.

Pole trigger 20 can be in line with cord 62 for controlling the supply of power to the rotary cutting tool 14. The rotary cutting device 14 can be configured to sense whether plug 58 or plug 64 is received in socket 60. When plug 64 is received in socket 60, the rotary cutting device 14 can be configured to disable the trigger switch 29 such that the rotary cutting device 14 cannot be activated, except by the pole trigger 20.

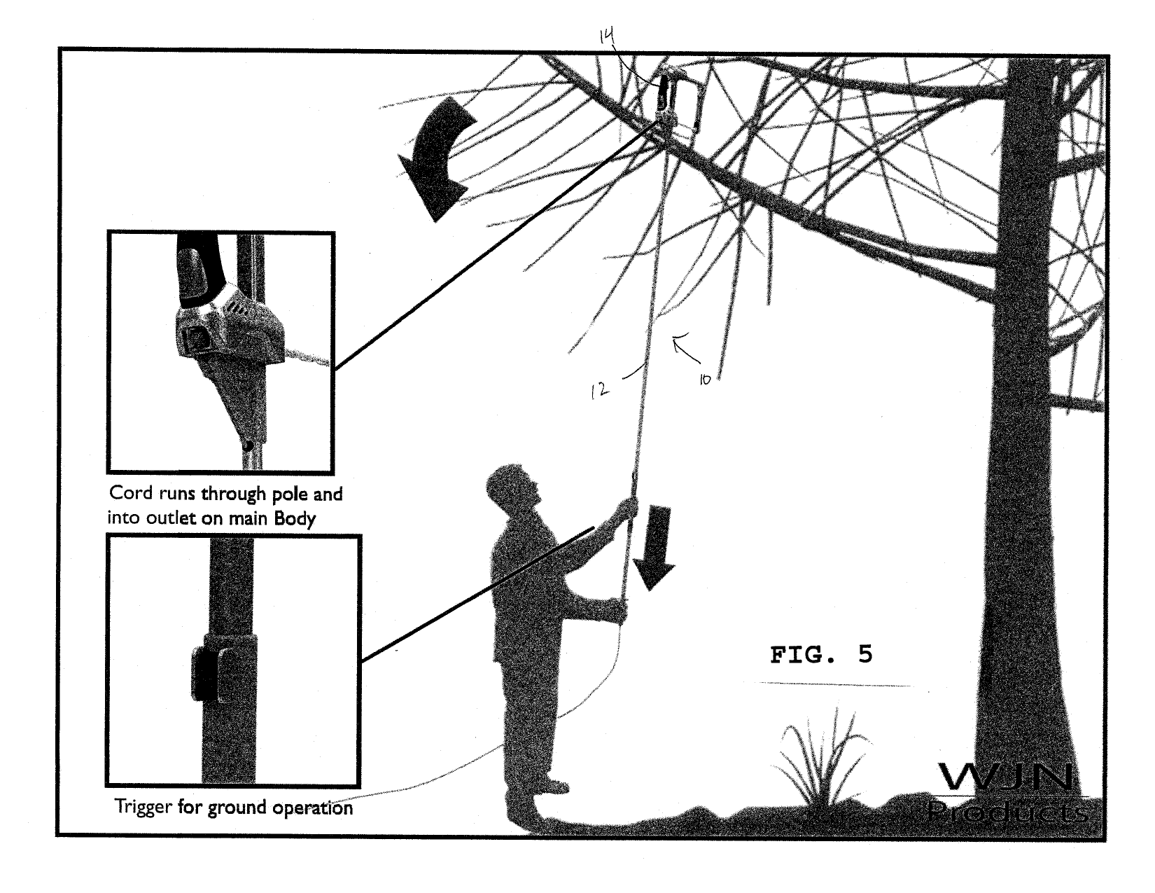

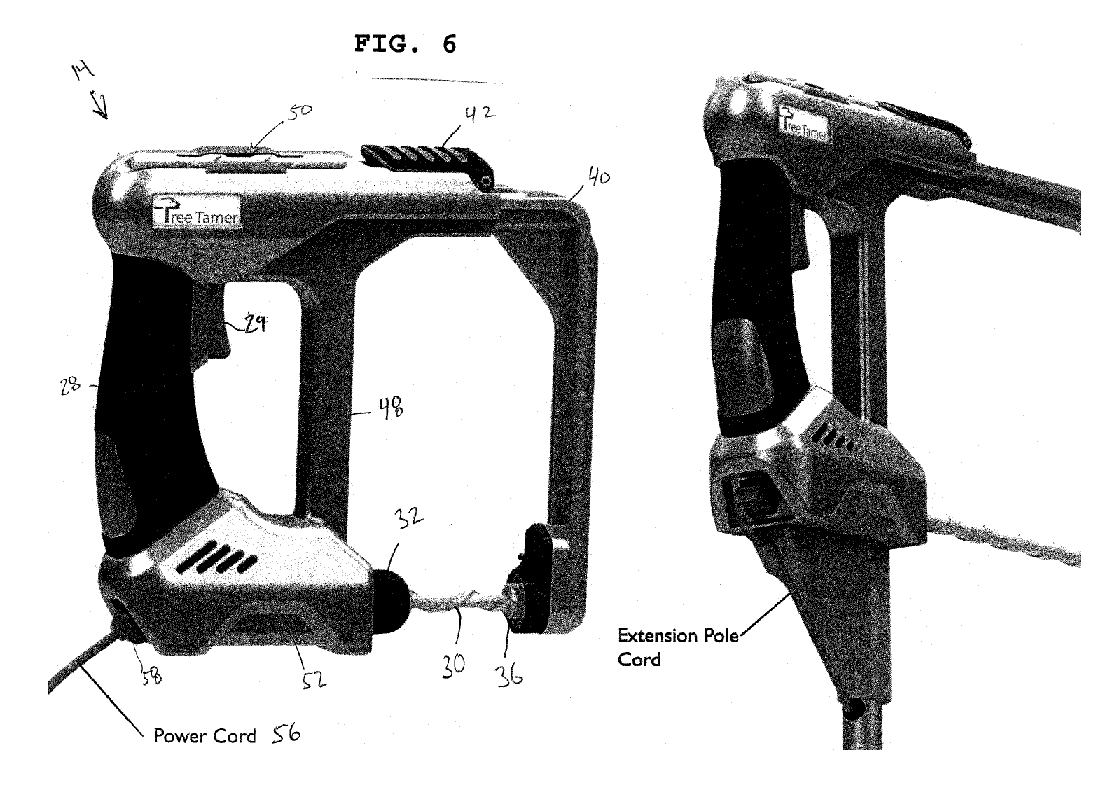

In FIG. 5, the exemplary cutting device 10 is shown in a position for trimming a branch of a tree. An operator is illustrated grasping the lower portion of the pole member 12 and positioning the cutting bit 30 slightly above the branch to be cut. With the rotary cutting device 14 activated, the operator draws downwardly on the pole member 14 thereby advancing the rotary cutting bit through the branch severing the end of the branch from that portion of the branch connected to the trunk of the tree.

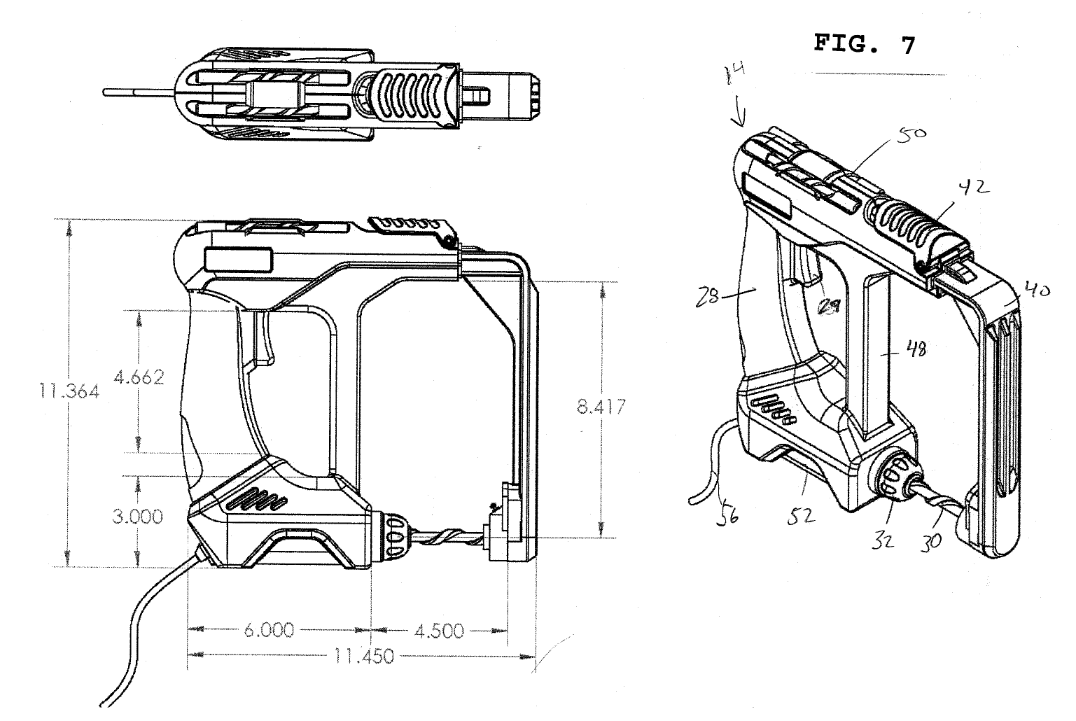

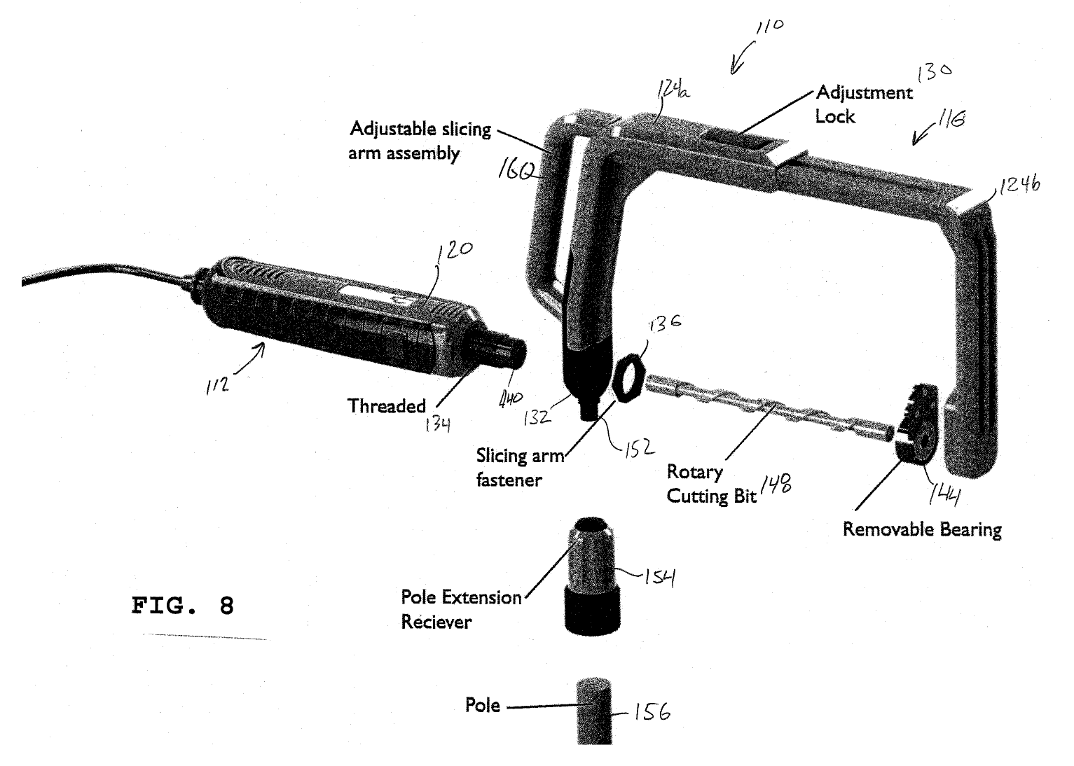

As shown in FIGS. 6 and 7, the rotary cutting device 14 as previously mentioned can be configured to accommodate rotary cutting bits 30 of various lengths. To this end, the rotary cutting device 14 as shown in FIG. 6 includes a rotary cutting bit 30 that is shorter than the rotary cutting bit installed in the rotary cutting devices of FIGS. 1-5. It will be appreciated that support arm 40 in FIG. 6 is illustrated in a generally fully retracted position thereby shortening the distance between chuck assembly 32 and bearing 36. By making the distance between chuck assembly 32 and bearing 36 adjustable, a wide range of lengths of bits can be used with the rotary cutting device 14. In addition, if a relatively long bit breaks during operation of the rotary cutting device 14, it may be possible to still continue to use portions of the bit by decreasing the space between the chuck assembly 32 and bearing 36 and mounting a portion of the bit therein. Thus, an operator in the field may be able to complete a job despite not having a replacement bit readily available.

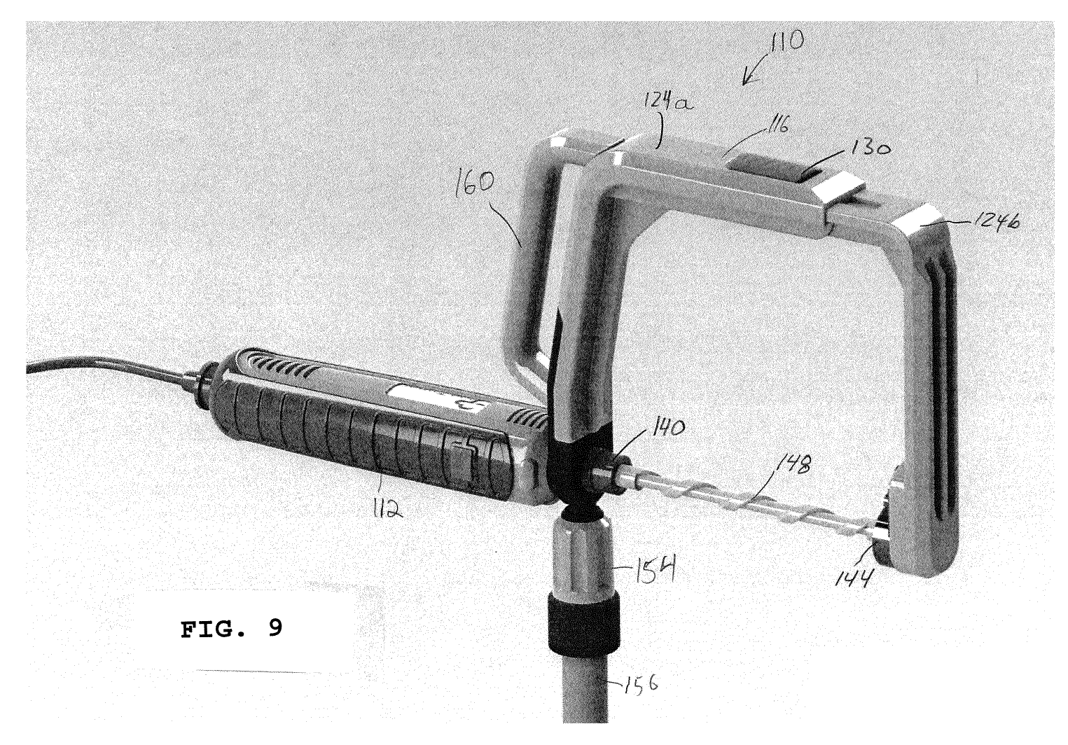

Turning now to FIGS. 8 and 9, another embodiment of a cutting attachment for use with an associated rotary tool is illustrated and generally identified by reference numeral 110. The cutting attachment 110 generally includes a rotary cutting bit support member 116 that is attachable to a housing 120 of another type of rotary tool 112. In the illustrated embodiment, the rotary cutting bit support member 116 includes first and second arm members 124a and 124b that are adjustably securable to each other via adjustment lock member 130. First arm member 124a is securable to the rotary tool 112. In the illustrated embodiment, the first arm member 124a includes a bore 132 for telescoping the first arm member 124a over a threaded shaft 134 of the rotary tool 112. A hex nut 136 secures the first arm member 124a to the rotary tool 112.

Similar to the tool 10 described in connection with FIGS. 1-7, the rotary cutting bit support member 116 is adjustable to vary a distance between a chuck or collet 140 of the cutting tool and a bit support provided on the second arm member 124b. With further reference to FIG. 9, the bit support, in this case, a removable bearing 144, is provided for supporting a distal end of a rotary cutting bit 148 when the rotary cutting bit 148 is installed in the collet 140 of the rotary tool 112. As will be appreciated, by adjusting the distance between the collet 140 and the removable bearing 144 through the adjustment of the first and second arm members 124a and 124b, various size cutting bits can be used with the attachment.

The first arm member 124a also includes a threaded shaft 152 for receiving a pole extension receiver 154 which in turn is configured to couple the attachment 110 to a pole 156 such that the overall assembly can be used remotely, for example, by an operator standing on the ground. FIG. 9 illustrates the assembled cutting attachment 116 coupled to a rotary tool 112 and to a pole 156 via pole extension receiver 154. As will be appreciated, the use of a pole 156 is optional and the cutting attachment 116 can be used as a hand-held version without the pole 156. In such case, an operator may grasp the rotary tool 112 as well as a handle member 160 provided on the cutting attachment 116. The handle 160 facilitates two handed operation of the device which can result in a more stable and accurate cutting operation.

As will be appreciated, the adjustment lock 130 can be any suitable mechanism for interlocking the first and second arm members 124a and 124b. In the illustrated embodiment, the adjustment lock can be a spring loaded interlock that acts to interlock the two arm members together. Depression of the adjustment lock 130 for example by an operator's thumb or other fingers releases the interlock allowing the arm members 124a and 124b to slide relative to each other for adjustment. Once a desired length is reached, the operator releases the adjustment lock 130 and the first and second arm members 124a and 124b are again interlocked and relative movement therebetween is restricted.

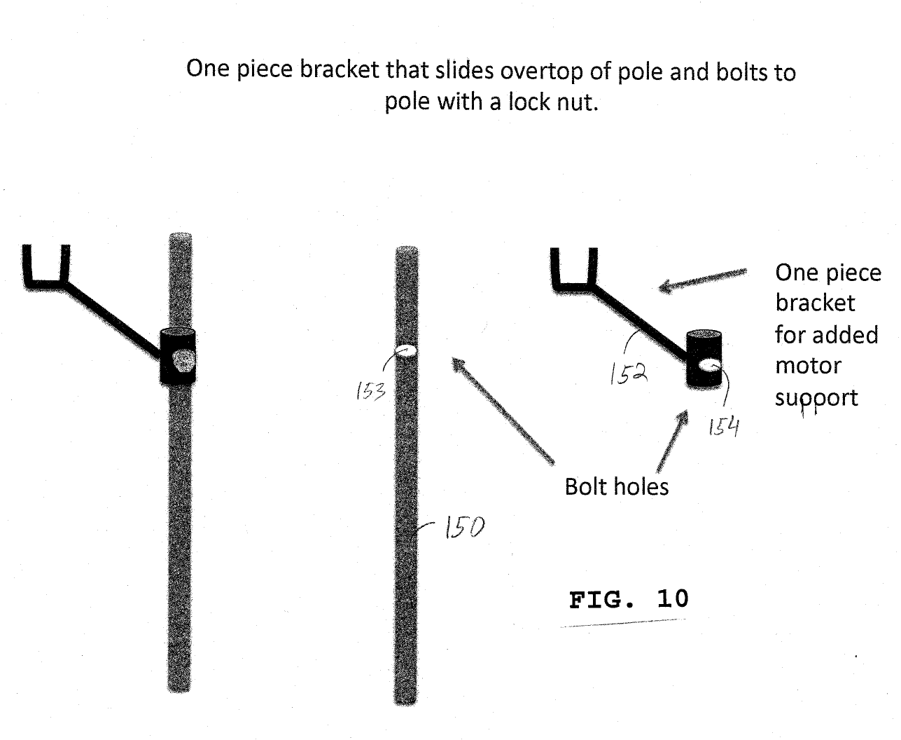

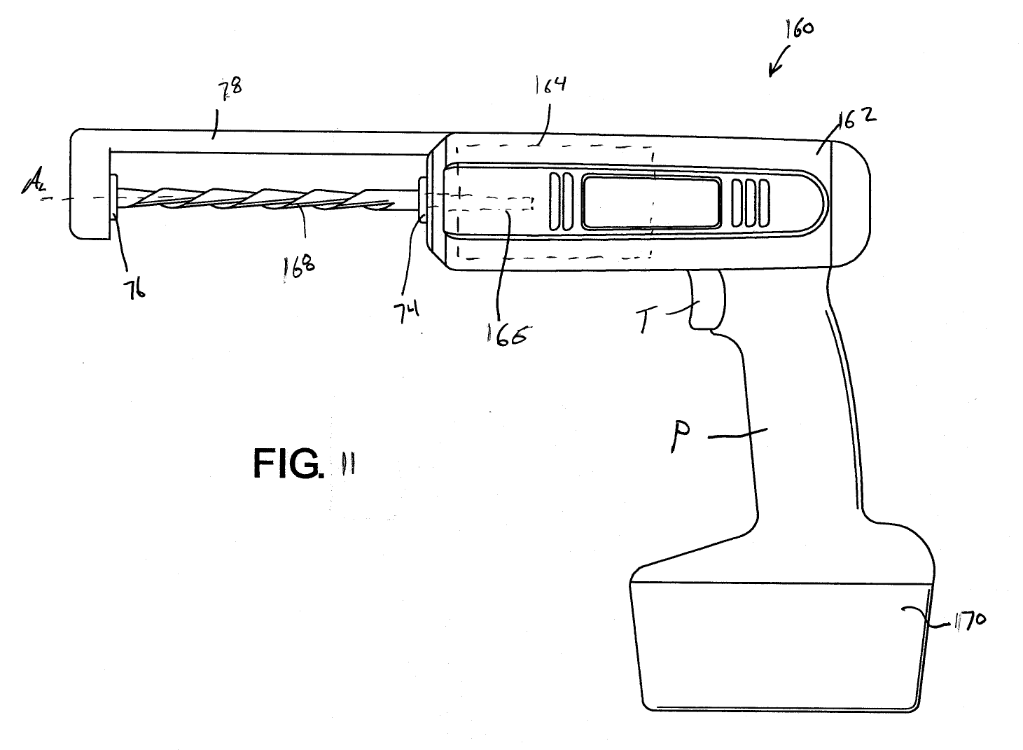

Still a further embodiment of the present disclosure is illustrated in FIGS. 10 and 11. FIG. 10 shows another type of pole 150 to which a one piece bracket 152 can be added for support of a rotary tool 160 illustrated in FIG. 11. Respective holes 153 and 154 allow the bracket 152 to be selectively mounted on the pole 150 via a fastener (not illustrated) extending therethrough. FIG. 11 shows a self-powered or battery powered rotary tool 160 including a battery 170. Also illustrated is a housing 162, a motor 164 supported within the housing and an output shaft 166 operatively connected to the motor for rotating a rotary cutting bit 168. The tool 160 can include a pistol grip P and a trigger switch T. Of course, if the tool is mounted on the pole, the tool will need to be actuated remotely as in the earlier embodiments disclosed herein.

First and second spaced apart bit supports are provided for supporting the rotary cutting bit 168 for rotation. These can take the form of a collet 174 that is supported on the output shaft 166 and is configured to engage a shank portion of the rotary cutting bit 168. The second bit support can include a bearing 176 supported on a bit support arm 178 which is in turn supported by the housing 162. Bearing 176 is adapted to receive the distal end of the rotary cutting bit 168 such that, along with the collet 174, the rotary cutting bit 168 is supported for rotation at two locations that are spaced apart along a longitudinal axis A_{L} of the rotary cutting bit 168.

The disclosure has been described with reference to the preferred embodiments. Modifications and alterations will occur to others upon the reading and understanding of the preceding detailed description. It is intended that the disclosure be construed as including all such modifications and alterations insofar as they come within the scope of the appended claims or the equivalents thereof. In addition, it will be appreciated that the various features of the different embodiments disclosed herein are interchangeable and/or combinable with other embodiments and/or other features thereof.

1. A cutting tool for cutting vegetation comprising:
an elongate pole member having a first end for supporting an associated rotary cutting bit and a second end opposite the first end for grasping by an operator during use;
a rotary cutting device supported at the first end of the elongate member, the rotary cutting device including a rotational drive member for spinning the associated rotary cutting bit, and first and second spaced apart bit supports for supporting the associated rotary cutting bit for rotation at spaced apart locations along its longitudinal axis;
wherein the cutting tool is configured for cutting vegetation with the associated rotary cutting bit between the first and second spaced apart bit supports while being manipulated by an operator grasping the elongate pole member.

2. A cutting tool as set forth in claim 1, wherein the rotary cutting device includes a motor for driving the associated rotary bit, and at least one of the first and second spaced apart bit supports is supported on an output shaft of the motor.

3. A cutting tool as set forth in claim 2, wherein the rotary cutting device further includes a housing in which at least a portion of the motor is contained, and a support arm extending from the housing supporting at least one of the bit supports.

4. A cutting tool as set forth in claim 3, wherein the support arm is removably attached to the housing.

5. A cutting tool as set forth in claim 3, wherein the support arm is adjustable to vary a longitudinal spacing between the first and second bit supports for accommodating bits of various axial lengths.

6. A cutting tool as set forth in claim 2, wherein the motor is at least one of an electric motor, a pneumatic motor, or a hydraulic motor.

7. A cutting tool as set forth in claim 1, wherein at least one of the first and second bit supports includes a collet for engaging a shank of the associated rotary cutting bit.

8. A cutting tool as set forth in claim 1, wherein the elongate pole member includes a telescoping portion for adjusting a length of the pole member.

9. A cutting tool as set forth in claim 1, wherein the elongate pole member includes a control mechanism located closer to the second end thereof for enabling a user to activate the rotary cutting device.

10. A cutting tool as set forth in claim 9, wherein the control mechanism includes a switch that is coupled to the rotary cutting device by a cord having a coupling member for coupling the switch to the rotary cutting device.

11. A cutting tool as set forth in claim 1, wherein the rotary cutting device is detachable from the elongate pole member and, further includes a trigger switch for handheld operation of the cutting tool.

12. A cutting tool as set forth in claim 3, wherein the housing includes at least one bit retainer for retaining an associated rotary cutting bit.

13. A cutting attachment for use with an associated rotary tool, the cutting attachment comprising:
a rotary cutting bit support member attachable to a housing of the associated rotary tool, the rotary cutting bit support member including at least one bit support for supporting an associated rotary cutting bit for rotation at a spaced apart location from the housing of the associated rotary cutting tool, whereby an associated rotary cutting bit can be supported at a first end by the associated rotary cutting tool and at a second end by the at least one bit support.

14. A cutting attachment as set forth in claim 13, wherein the rotary cutting bit support member includes first and second arm members, the first arm member securable to the associated rotary tool, and wherein the second arm member is adjustably securable to the first arm member to vary a longitudinal spacing between the housing of the associated rotary tool and the second member.

15. A cutting attachment as set forth in claim 14, further comprising an adjustment lock mechanism for selectively locking the first and second arm members together in a plurality of positions.

16. A cutting attachment as set forth in claim 13, wherein the rotary cutting bit support further includes a pole extension receiver removably attachable to the rotary cutting bit support, the pole extension receiver adapted to receive a pole member.

17. A cutting attachment as set forth in claim 13, wherein the at least one bit support includes a bearing.

18. A cutting attachment as set forth in claim 17, wherein the bearing is removable from the rotary cutting bit support member.
